(19) United States
(12) Patent Application Publication
(10) Pub. No.: US 2006/0136105 A1
(43) Pub. Date: Jun. 22, 2006

(54) Interactive data exchange system for vehicle maintenance scheduling and up-time optimization

(76) Inventor: Gerald L. Larson, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/015,695

(22) Filed: Dec. 17, 2004

(51) Int. Cl. G06F 19/00

(52) U.S. Cl. 701/30; 701/29; 701/33

(57) ABSTRACT

Vehicle telematics is employed to improve maintenance scheduling by facilitating collection and integration of vehicle condition information from diverse sources. These sources include real time data collected from vehicle sensors over an intelligent vehicle controller area network. The network is provided with facilities for generating records with stamps allowing their correlation with vehicle inspection results and the generation of trend reports to be used in scheduling maintenance.

### BACKGROUND OF THE INVENTION

1. Technical Field

The invention relates to vehicle telematics and more particularly to a system providing interaction between information processing facilities on a vehicle, at maintenance providers and under the control of the vehicle owner to optimize maintenance scheduling in accordance with operator objectives.

2. Description of the Problem

Periods when commercial vehicles must be removed from service for maintenance is costly to vehicle operators. Unplanned maintenance can be particularly burdensome. Better anticipation of maintenance needs may allow an operator to stagger servicing of vehicles, to better anticipate maintenance needs and to route and schedule vehicles to minimize transit time to service facilities and to synchronize required service procedures with one another.

Cost effective sensors which can accurately provide data directly relating to the condition of vehicle fluids such as engine oil and transmission fluid are not generally available at the time this is being written. Such on board sensors as exist for engine, drive train and electrical system functions are useful for the identification of faults and are used for indicators or for implementing control of the vehicle, but have limited predictive capacity. Accurate assessment of the condition of engine oil, by way of example, has depended upon spectrographic analysis conducted on samples of engine oil drawn from a vehicle and sent to a industrial laboratory for analysis and has not been directly available from the vehicle.

Present maintenance practice frequently involves acquiring information by direct inspecting and manually recording the observations. For example, when a vehicle is serviced an oil sample may be drawn and sent to an outside laboratory for analysis. The results are typically returned to the service facility hard copy report after a few days. The maintenance manager then reads the results, and, if the results are within in limits, the analysis report is filed for future reference or discarded. If the result is out of limits, a maintenance manager may identify the issue on the basis of personal experience or by calling the laboratory for aid. Obtaining an overview of trends, and correlation of the results with data relating to vehicle use has not generally been possible.

### SUMMARY OF THE INVENTION

According to the invention there is provided a data integration system for motor vehicle service scheduling. The data integration system comprises a central data repository which receives data from diverse sources to improve operator facility for maintenance scheduling. These sources include an integrated data network and sensor package installed on at least a first motor vehicle for generating vehicle data. A vehicle service facility provides for periodically inspecting motor vehicles including the first motor vehicle and generating inspection data. Vehicle fluid analytical services provide for analyzing fluid samples drawn from the motor vehicles and generating data relating to the results of the analysis.

Data communication facilities including internet, satellite and short range radio links couple the various data generated by the integrated data network and sensor package, at the vehicle service facility and through the vehicle fluid analytical services to the central data collection facility. The central data repository including database services for facilitating organized recordation and retrieval of the data for comparison analysis. A website generated by the central data repository may be used for display of results from the comparison analysis for operator use in scheduling maintenance.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic of a telematics systems adapted for data condition data collection and integration system for enhancing commercial vehicle in service time.

FIG. 2 is a block diagram of a vehicle controller area network control system adapted for use in the data collection and integration system of FIG. 1.

FIG. 3 is a simplified flow chart related to vehicle onboard data collection and reporting.

FIG. 4 is a simplified flow chart relating to data collection by a service operation and associated laboratories.

FIG. 5 is a flow chart for a service scheduling management operation implemented using various telematic sources.

FIG. 6 is a representative display of trends and analysis posted to a website.

FIG. 7 is a time line illustrating opportunities for service synchronization.

### DETAILED DESCRIPTION OF THE INVENTION

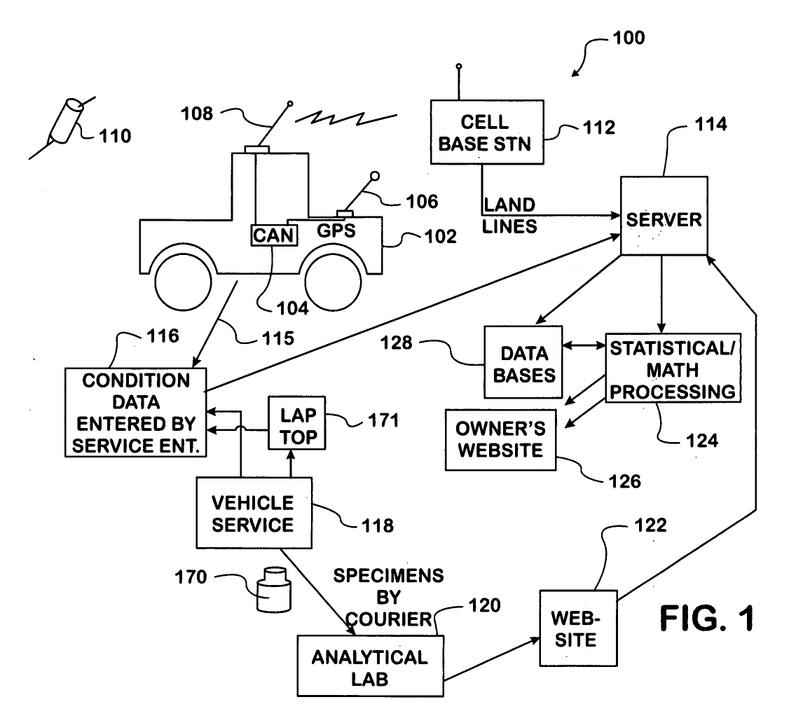

Referring now to the figures and in particular to FIG. 1, a generalized vehicle telematics system 100 is illustrated. Vehicle telematics system 100 may be implemented using one, or more typically, a large plurality of commercial vehicles 102, which communicate with a vehicle operator server 114 using any convenient means, but typically using a cellular telephone link 108 to link with a cellular base station 112 or short range RF link.

Commercial vehicle 102 includes an electronic control system based on a controller area network (CAN) system 104. Controller area network system 104 links numerous controllers onboard commercial vehicle 102 for data communication and allows central activation and control of remote data communications services as through cellular phone link 108 and use of services such as global positioning using a global positioning unit 106 reading GPS satellites 110.

As is conventional, cell phone base station 112 is linked by land lines including, if advantageous, internet services, to transfer data from cell phone link 108 to a vehicle operator's server 114. The data from the vehicle 102 can include, as set forth in detail below, information relating to engine loading, extreme brake use and other vehicle operating variables collected by the CAN system 104 as well as conventional telematics services. Records forwarded from vehicle 102 are time, date, location and mileage stamped. Data can be forwarded from a vehicle over a cell phone link by connection 115 (such as short range RF or direct hand wire connection) to a service tool at a maintenance base.

Server 114 also collects data from other sources including at least a first remote service provider server 116, such as an independent engine maintenance facility. Data collected in the course of vehicle service 118, such as mileage at the time of service, tire tread depth, vehicle damage, etc. is entered through a lap top computer for placement on server 116 and from there forwarded to server 114. In addition, fluid specimens, particularly engine oil samples may be drawn and sent in standardized containers 170 using a courier, freight or postal service to an analytical laboratory 120 to be analyzed. The results of the analysis are then placed on a secure website 122 to be accessed by server 114.

Server 114 maintains databases of vehicle statistics indexed by mileage on databases 128. These records allow trends to be detected by comparison operations 124 with the results being placed on a second secure website 126 for the use of management.

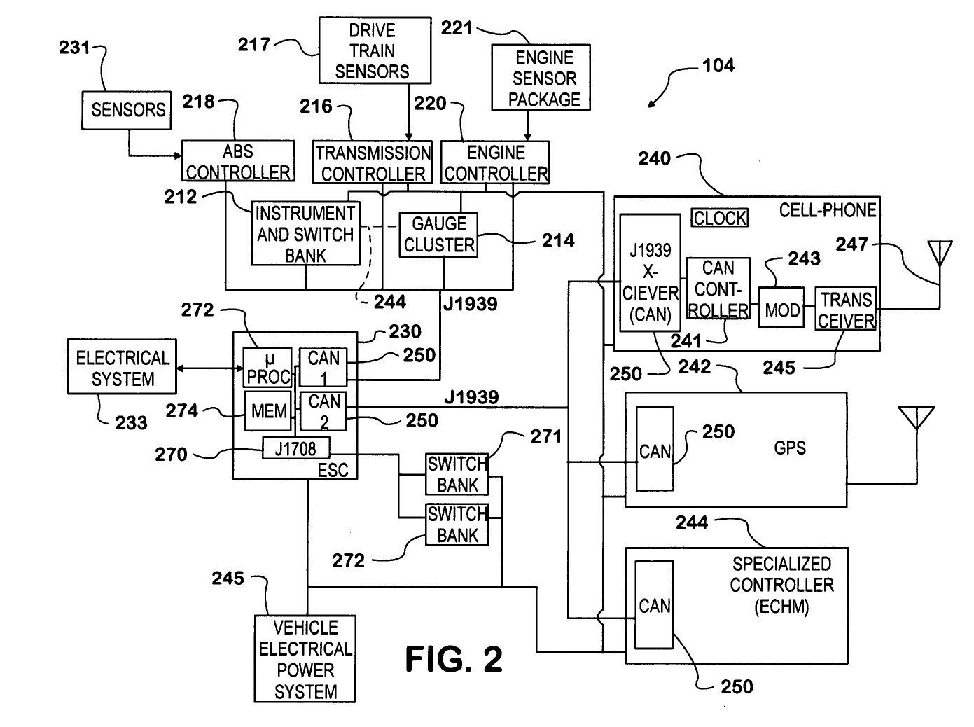

Referring now to FIG. 2, the features of a controller area network system 104 such as used on a commercial vehicle are set out. Controller area network 104 has as foundational elements a programmable body computer 230 based on a microprocessor 272 and memory 274, which may in turn include both volatile and non-volatile sections (not shown). Microprocessor 272 communicates with other parts of the programmable body computer 230 over a conventional bus. Among the other parts of the computer are input/output devices for handling network communications including first and second controller area network (CAN) interfaces 250 and a SAE J1708 interface 270. The J1708 interface generally is used for handling extremely low data rate devices such as banks 271, 272 of switches. A vehicle electrical power system 245 provides power to all of the components.

CAN system 104 includes two distinct controller area networks based on a first bus using the public codes of the Society of Automotive Engineers (SAE) standard for J1939 networks and a second using proprietary codes, the definition of which is allowed under the standard. By “proprietary” it is meant only that standard format J1939 data block may be defined as desired by an OEM. The public bus connects first CAN interface 250 to a plurality of system controllers including an instrument and switch bank 212, a gauge cluster 214, an anti-lock brake system controller 219, a transmission controller 216 and an engine controller 220. Any of these controllers may in turn be connected to one or sensors of packages of sensors associated with a specific controller. For example, ABS controller 219 collects data from sensors 231 which include at least the wheel speed sensors used for determining skidding. Transmission controller 216 may track transmission fluid levels or include a drive shaft tachometer from drive train sensors 217. By far the most important collection of sensors though is the engine sensor package 221 connected to the engine controller 230 which includes an engine tachometer, an air intake temperature gauge (providing a reasonable reading of ambient temperature), coolant temperatures, and engine oil temperature, level and dielectric constant readings.

Body computer 230 is itself a controller and can be used for direct monitoring of vehicle components, such as the working status of lights connected to an electrical system 233. Body computer 230 operates as a controller on two distinct CAN busses. Devices using proprietary codes are coupled to the second bus and here include a GPS receiver unit 242, a specialized controller 244 and a cell-phone transceiver unit 240, each of which include a CAN interface 250. Transceiver unit 240 additionally a microcontroller 241, a modulating unit 243 and a transceiver unit 245 connected to an antenna 247. Data collected by body computer 230, mostly over the first CAN network, is transferred using code blocks defined for that function over the second CAN network to cell phone unit 240 where it is used to modulate a carrier for transmission. Body computer 230 has access to data such as mileage and to clock information, as well as GPS data, allowing the body computer to stamp data records as to time, date, mileage and location relating to sensor reading falling outside of normal reading categories or otherwise meeting some criteria defined by the operator. This is based on a need or desire to maintain the record for use of the central server 114.

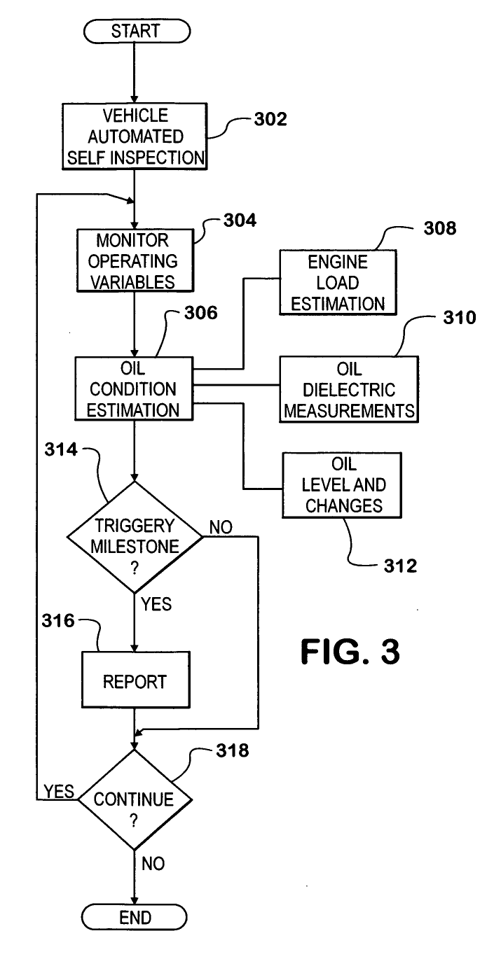

Representative flow charts illustrate the collection of data. Referring to FIG. 3, a flow chart is used for describing operations at the vehicle level supporting the system and process of the present invention. Upon start of a vehicle, or the beginning of a new day, the vehicle may execute a partially automated inspection of itself (step 302) as required by applicable federal regulation. A record of this inspection is stored in memory. Next, at step 304, vehicle operation is assumed to have commenced and values for various vehicle-operating variables are monitored. These values may be from time to time stored in memory. More importantly, the values may be used by the electrical body computer 230 or engine controller 220 to make an estimate of engine oil condition (step 306). The factors monitored supporting engine oil condition estimation include estimates of engine load (step 308), engine oil dielectric measurements and oil level (step 310) and changes, particularly large changes over time, in oil level (step 312), and potentially vehicle exhaust quality.

Collected data is reported upon interrogation of the vehicle or upon internally triggered reporting conditions being met (step 314). Whenever triggering conditions are met step 316 is executed to report selected results to a server 114. Whether results are reported or not step 318 provides for determining if conditions indicate discontinuing monitoring variables (or alternatively, the need to re-execute the automated self inspection routing) or whether it is necessary only to continue with routine operations.

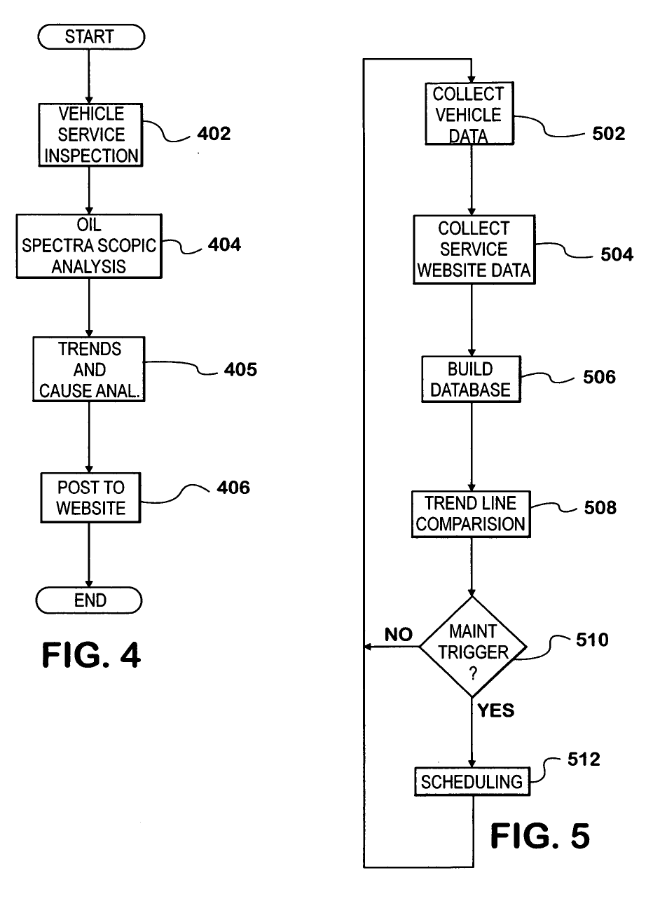

FIG. 4 relates to steps executed by vehicle service providers. Upon inspection of a vehicle (step 402) various data are collected including, by way of example, vehicle mileage, tire tread condition and most importantly, the spectroscopic analysis of engine oil (step 404). Results are analyzed and trends (and possible causes where trends are adverse) are developed (Step 405). The results of the inspection are posted to a secure website (step 406) for interrogation by server 114.

FIG. 5 lays out operation of server 114. Vehicle data is periodically collected (step 502) upon initiation by either the vehicle or server 114. All of the various websites where data relating to a vehicle may be posted is also collected (step 504). The collected data is used to add records to a database (step 506). Databases can then be accessed to build trend lines for comparison and prediction purposes (step 508). Should trend lines point to an imminent requirement for maintenance, scheduling for maintenance is indicated along the YES branch from step 510 to step 512. Along either the NO branch or after scheduling (step 512) the procedure loops for continued monitoring.

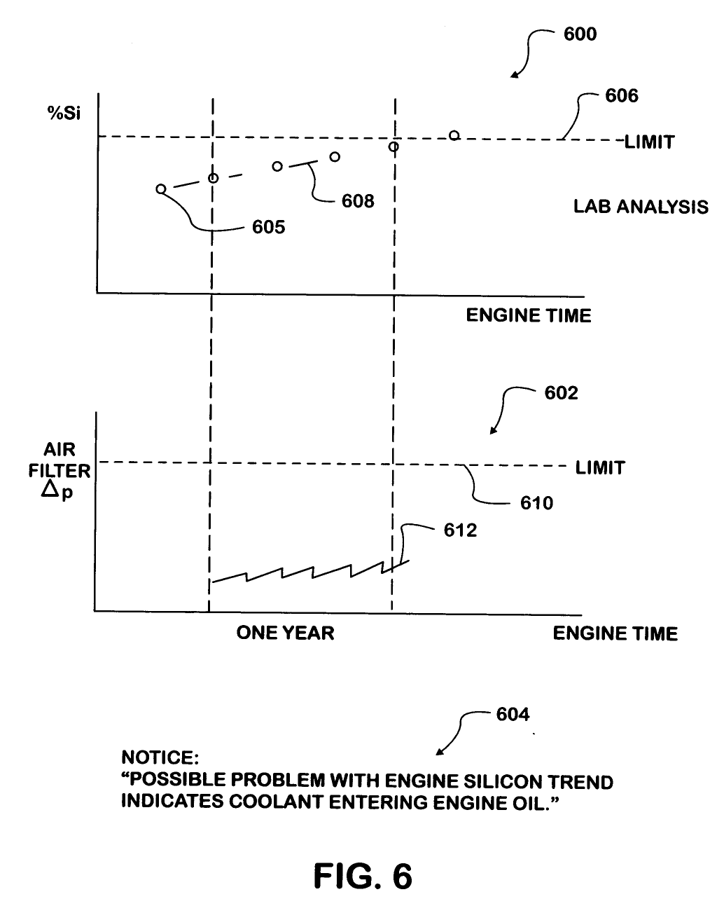

Referring to FIG. 6, an example of a graphic display 600 of potentially related trends and an analysis of the possible significance of simultaneous occurrence of the trends is presented. The first, uppermost graph is one of silicon infiltration into engine oil. A series of samples 605 lie along a trend line 608 which increases over time toward and exceeding a limit 606. The presence of silicon in engine oil generally comes from one of two sources, ingestion through the air intake of air borne material or infiltration from engine coolant. Silicon from the air occurs as dust or fines blown or suspended in the air. They can be expected to clog air intake filters. Accordingly, the graph 600 has been time correlated to an air filter delta pressure graph 603. If the vehicle had been encountering suspended or blown bust, the trend line 612 of the air pressure drop across the air intake filter should show radical changes toward a limit value 610. Here no such correlation occurs. The ingestion of air borne partialates is thus unlikely to be the cause of engine oil contamination and a cautionary notice 604 is included with the graphs 600, 602 to the effect that engine coolant infiltration into engine oil should be considered.

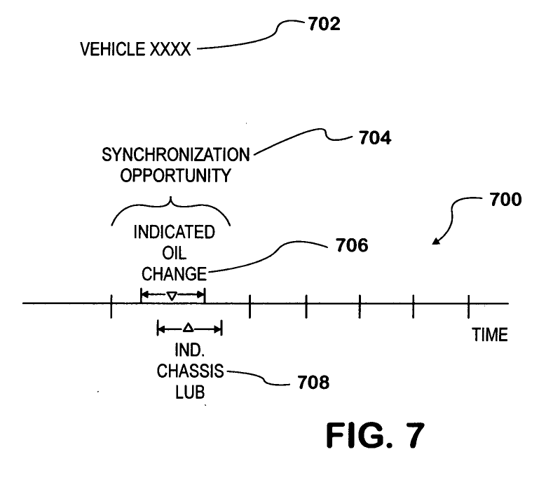

Referring to FIG. 7, a time line graphic 700 may be generated for display to a web page. The time line 700 is for a vehicle identified by a label 702. A note 704 is generated to alert a service manager that trends (possibly generated by on board vehicle condition monitoring sensors and data processing) that indicate the need for an oil change 706 and for a chassis lubrication 708 should mature within a limited time frame with respect to one another, giving rise to an opportunity to do both tasks at the same time without exceeding limit periods in which to do either operation. In essence, the preferred time frames for doing the operations at least overlap.

The subject invention draws information from three types of sources: (1) data acquired directly from vehicle sensors and systems; (2) laboratory analysis data; and (3) vehicle component condition data entered by a vehicle service agency. Ideally, the information is acquired on a real time basis and transferred to a central sever computer as part of a communication linkage component of the telematics system. Service facilities are to be equipped with sampling containers from a contracted with laboratory to facilitate the collection of data generated by analytical work. When the vehicle is serviced, vehicle information (mileage, tire tread depth, etc.) is entered via an interactive web page that can be displayed on a portable computer. Fluid samples are shipped by expedited means to the laboratory. Analysis results are electronically provided to the telematics service provider (typically the vehicle operator, or potentially yet another service provider) by the laboratory. The server computer merges vehicle data, service center data and laboratory analysis results to derive various types of information relating to scheduling vehicle maintenance. These are: (1) vehicle “State-of-Health”, a weighted score of the faults, component condition and performance compared against standards; (2) trends reports, i.e. indications of engine wear based on metals occurring in the fluid samples, excessive tire wear, etc. and possible causes of the trends; (3) next service interval, based on timing, subsystems needing service, shop availability vehicle routing and synchronization of procedures; and (4) occurrences of out-of-limits vehicle operation (e.g. excessive speed, braking, operating temperatures, etc.).

The advantages of such a system relate particularly to correlation of fluid analysis with vehicle operating variable excursions into out of bounds areas. For example, an oil analysis report may indicate that a sample had a low viscosity. The real time vehicle information can then serve to indicate as a possible cause of the low viscosity an occasion of an engine temperature excursion correlated with a time and location stamp.

While a telematics system is preferred, other system configurations are possible. For example, the vehicle on-board computer could acquire and hold data for later downloading by direct link or short-range radio connection for transfer to the central server. However, the system elements will include: (1) vehicle onboard electronics to sample and store engine, drive train and vehicle performance data; (2) data transferal to the central server; (3) quantitative analytical inputs; and (4) a real time system (e.g. electronic, optical) for the dissemination of results to an end user. Record keeping is centralized.

While the invention is shown in only a few of its forms, it is not thus limited but is susceptible to various changes and modifications without departing from the spirit and scope of the invention.

What is claimed is:

1. A data integration system for motor vehicle service scheduling, the data integration system comprising:
a central data repository;
an integrated data network and sensor package installed on at least a first motor vehicle for generating vehicle data;
a vehicle service facility for periodically inspecting motor vehicles including the first motor vehicle and generating inspection data;
vehicle fluid analytical services for analyzing fluid samples drawn from the first motor vehicle and generating data relating to the results of the analysis;
data communication facilities for coupling the various data generated by the integrated data network and sensor package, at the vehicle service facility and through the vehicle fluid analytical services to the central data collection facility;
the central data repository including database services for facilitating organized recordation and retrieval of the data for comparison analysis; and
a website generated by the central data repository for display of results from the comparison analysis.

2. A data integration system as set forth in claim 1, the data communication facilities further comprising:
a radio-based link facilitating real time transfer of vehicle data to a central sever computer as part of a vehicular telematics package.

3. A data integration system as set forth in claim 2, further comprising:
standardized sampling containers for transferring fluid samples drawn from vehicles at the vehicle service facility for transfer to the vehicle fluid analytical services.

4. A data integration system as set forth in claim 2, the integrated data network and sensor package further comprising:
a public vehicle controller area network;
a vehicle body computer;
a plurality of controllers coupled for communication with the vehicle body computer over the public vehicle controller area network;
a private vehicle controller area network; and
communication and position locating facilities coupled to the vehicle body computer over the private controller area network to enable stamping of records for forwarding to the central data repository.

5. A data integration system as set forth in claim 4, further comprising:
a plurality of sensors, each sensor being coupled to one of the plurality of controllers.

6. A data integration system as set forth in claim 5, further comprising:
the vehicle body computer being programmed to execute engine oil condition prediction routines.

7. A data integration system as set forth in claim 6, further comprising:
the data communication facility between the vehicle fluid analytical services and the central data repository including a website on which the data generated by the vehicle fluid analytical services is placed for retrieval.

8. A data integration system as set forth in claim 7, further comprising:
means associated with the central data repository for determining service intervals for the at least first motor vehicle.

9. A method of determining motor vehicle service intervals, the method comprising the steps of:
providing a central data repository;
collecting data relating to vehicle operating variables generated by sensors installed on a selected motor vehicle;
selecting data from the collected data and forwarding the selected data to the central data repository on a real time basis;
periodically inspecting the selected motor vehicle at a service facility;
making the results of the periodic inspections at the service facility available to the central data repository;
as part of the periodic inspection drawing fluid samples from the selected motor vehicle;
sending the fluid samples to fluid analytical services for component analysis;
making the resulting data from the component analysis available to the central data repository; and
determining from the data collected at the central data repository a service interval for the selected motor vehicle.

10. A method of determining motor vehicle service intervals as set forth in claim 9, the service interval-determining step further comprising the steps of:
organizing the collected data into databases relating to the selected motor vehicle; and
generating trend lines over time or mileage for vehicle operating variable value and at least a first possible cause of the trend.

11. A method of determining motor vehicle service intervals as set forth in claim 10, further comprising the step of:
generating displays of the trend lines to system operators for determinations regarding service intervals.

12. A method of determining motor vehicle service intervals as set forth in claim 10, further comprising the step of:
comparing trend lines against predetermined norms for determining service intervals.

13. A method of determining motor vehicle service intervals as set forth in claim 12, the steps of making data available to the central data repository including the step of posting the data to websites for access by the central data repository.

14. A method of determining motor vehicle service intervals as set forth in claim 13, further comprising the step of:
generating a vehicle State-of-Health score as a weighted score of the faults, component condition and performance compared against standards.

15. A method of determining motor vehicle service intervals, further comprising the steps of:
recording time and location occurrences of out-of-limits vehicle operation including excessive speed and braking in the database; and
correlating out of limits operation with out of record time and location occurrences of out-of-limits operation.
